(19) United States
(12) Patent Application Publication
(10) Pub. No.: US 2008/0202412 A1
(43) Pub. Date: Aug. 28, 2008

(54) Device for Applying Fluids to a Contour of a Substrate

(75) Inventors: Thomas Burmester, Bleckede (DE); Thomas Meyer, Oerzen (DE)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/817,813

(22) PCT Filed: Apr. 19, 2006
(86) PCT No.: PCT/US06/14640

§ 371 Date: Sep. 5, 2007

(30) Foreign Application Priority Data
Apr. 20, 2005 (DE) 202005006368.1

(51) Int. Cl. B05C 1/04

(52) U.S. Cl. 118/262

(57) ABSTRACT

An application device (2) for applying fluid to a contour of a substrate, having a transfer wheel (4) for transferring the fluid from a fluid dispensing device (6), in particular a dispensing nozzle (18), onto the contour of the substrate, characterized in that the transfer wheel (4) has an axially tapering transport surface for transporting the fluid onto the contour.

### TECHNICAL FIELD

The present invention generally relates to an application device for applying fluid to a contour of a substrate.

### BACKGROUND

Various devices are employed in order to apply free-flowing materials (referred to hereinafter as fluids) such as cold glue, hot melt adhesive, paint, varnish or the like to contours of various objects (referred to hereinafter as substrates). For example, in the manufacturing of floor covering elements such as panels of wood or laminate, an additional edge refinement is performed by coating the chamfered edge areas.

For applying fluid to a substrate, nozzles have been used to apply the fluid directly onto the substrate as dots or beads, or also to spray the fluid directly onto the substrate. However, such devices and methods for direct application exhibit difficulties with precise and simultaneously rapid application. In addition to precise positioning, dispensing devices also require costly regulating equipment, since over-application of fluid can result in the fluid running on the substrate, particularly at the contoured edges.

Use of a transfer wheel is known for applying a fluid to, a contour of a substrate in a simple way. Here, the fluid is applied to the circumferential surface of a cylindrical transfer wheel and transported to the substrate by the rotary motion of the wheel. The transfer wheel touches the substrate only at the contour, such as at a substrate edge, for example. Fluid is transferred from the transfer wheel to the contour of the substrate by contact. Even after the transfer of fluid to the substrate, a significant quantity of fluid remains behind on the transfer wheel. To achieve a uniform quantity of fluid on the transfer wheel, part of the remaining fluid is removed from the surface of the transfer wheel by an additional wheel. Here the transfer wheel and the additional wheel run together like two spur gears, with fluid that is to be removed being squeezed out at their contact point or the point of closest approach.

A disadvantage in using such a transfer wheel is that when the transfer wheel rotates at an adequate speed the fluid is thrown tangentially from the transfer wheel and thereby regularly contaminates the adjacent working space. To ensure uniform and gapless fluid application, it is also necessary to apply a large volume of the fluid to the transfer wheel, which further amplifies the effect of throwing off fluid by centrifugal force.

Providing a catch container is impractical, since such a catch container would have to surround not only the actual application device but also the entire substrate transport system.

### SUMMARY

In one aspect of the invention, rotary motion of the transfer wheel causes a centrifugal force directed radially outward to act on the fluid that is on the transport surface of the transfer wheel. However, because of the axially tapered shape of the transport surface and the adhesion force acting on the fluid, the centrifugal force initially results in a movement of the fluid from areas of the transport surface with smaller diameter to areas of larger diameter. Thus during the rotation of the transfer wheel there is a continuous flowing movement of the fluid on the transport surface toward the largest diameter of the transfer wheel. The result is that fluid is not immediately thrown from the transfer wheel, but that first a flowing motion takes place on the transport surface, so that a time advantage is achieved. A further advantage which results is that in the event that fluid is thrown off it does not become detached over the entire transport surface, but only in a defined area, namely at the largest diameter of the transport surface.

The invention thus achieves both a delay in the throwing off of fluid and a local defining of the “throwing zone.”

Through the use of a doctor blade to smooth the fluid on the transport surface of the transfer wheel, it is also possible to achieve uniform distribution of the fluid on the transport surface in a simple way. To this end, the doctor blade only needs to be positioned firmly with its working edge, which may be knife-like, for example, close above the transport surface. In this case, for smoothing, the doctor blade is located after the dispensing nozzle and before the contact point of the transfer wheel with the substrate, measured by the direction of motion of the transfer wheel in operation. In operation, fluid is deposited on the transport surface of the transfer wheel by the fluid dispensing device. This fluid is then smoothed by the doctor blade and at the same time is thereby distributed uniformly on the transport surface. The fluid, which is thus uniformly smoothed and distributed, then reaches the contact point with the contour of the substrate on the transport surface, and thereby leads to a uniform application of fluid to the contour. Hence, uniform application on the contour is achievable by means of a transfer wheel, even with little fluid.

When a doctor blade is used for wiping, it is positioned after the contact point of the transport surface with the contour and the fluid dispensing device, again measured by the direction of motion of the transfer wheel in operation. In this way surplus fluid, i.e., fluid that has not been transferred to the contour, can be completely or partially removed from the transport surface in a way that involves a simple design, so that the transport surface moves on from this doctor blade with a defined quantity of residual fluid, which can also be zero. Hence a uniform application of fluid is prepared for by this doctor blade.

The transport surface may have the shape of the circumferential surface of a truncated cone. Such a conical form can be produced in a simple way, and thus cost-effectively. In axial section it has a straight sectional edge. The working edge of a doctor blade, if any, can also be matched to the shape of this edge, so that such a doctor blade, if any, can also be shaped easily and inexpensively.

In principle, the angle between the wheel axis and the axial cross sectional edge can have any value, since it depends on a multitude of parameters such as the viscosity of the fluid, the mean radius of the transfer wheel, the speed of rotation of the transfer wheel in operation, the breadth of the transfer surface and the shape of the substrate, in particular its contour. However a range from 20° to 70° can be named as the preferred range, since this differs significantly from both the circumferential surface of a cylinder and the end face of a cylinder. In the range between 30° and 60° this differentiation is even clearer, as are the effects according to the invention. An angle of 45° can be regarded as a favorable mean value under average limiting conditions.

It should not be forgotten, however, that other forms of the transport surface than that of the circumferential surface of a truncated cone are also possible in principle. For example, shapes can be considered in which the axial cross sectional edge of the transport surface has an inward or outward curve, similar to a hyperbola or parabola. Also possible is a sectional edge that is made up of curved and/or straight sections.

In a favorable design, a catch container for capturing surplus fluid is provided. Such surplus fluid collects for example on a doctor blade while wiping or smoothing, and oozes off of it. The catch container can also capture fluid that is thrown off directly from the transfer wheel. It is advantageous here for the catch container to be of essentially funnel-shaped design. The fluid is thus captured to the side of and below the application device, in particular the transfer wheel, and is brought together and collected by the funnel shape. As a rule it is not necessary to cover the application device or transfer wheel from above during operation. The fluid collected in the funnel can be returned to the fluid dispensing device, and thus recycled.

By preference, the transfer wheel, in particular its transport surface, is partially surrounded by the catch container. Since surplus fluid occurs essentially only on the transfer wheel, it is sufficient to surround the transfer wheel with the catch container in and beneath these zones. It is advantageous for the transport surface to protrude part way out of the catch container, in particular with a zone of smaller diameter. This draws the full benefit of the design of the transport surface according to the invention. The area of the transport surface with a smaller diameter is used to transfer the fluid to the contour of the substrate. That is, only the area of the transport surface that protrudes from the catch container comes into contact with the contour. Therefore, the substrate can be guided outside of the catch container.

Because of the rotary motion of the transfer wheel, fluid, in particular surplus fluid on the transport surface, flows in the direction of the greatest diameter of the transfer wheel, and may be thrown off there. This section of the transfer wheel is therefore surrounded by the catch container, so that the fluid that is thrown off can be captured. Thus it is possible in a simple and inexpensive way to provide a catch container which itself captures fluid thrown off from the transfer wheel, while at the same time it does not hinder guiding the substrate past the transfer wheel.

According to a preferred embodiment, the particular wiping or working edge of the doctor blade may be positioned essentially perpendicular to the direction of motion of the transport surface in operation, and the doctor blade is at the same time essentially perpendicular to the transport surface. At the same time, the particular working edge of the doctor blade may be positioned at the transport surface or at a slight distance from the transport surface, and assumes essentially the shape of the axial sectional edge of the transport surface. By this arrangement, a slit of predetermined size is formed between the transport surface and the doctor blade. The motion of the transfer wheel moves the fluid toward this slit, and when it reaches the doctor blade it is shaped to the size of the slit. The fluid thus assumes a uniform coating on the transport surface after the doctor blade in the direction of motion.

If the working edge of the doctor blade is positioned on the transport surface with no gap, the rotation of the transfer wheel causes complete removal of the fluid from the transport surface, similar to scraping it off. If the fluid cannot be conveyed through between the transport surface and the doctor blade as the transfer wheel rotates, it accumulates on the one side of the doctor blade and drips from there into a collecting container.

Positioning the doctor blade obliquely to the transport surface would cause either a lifting of the fluid, similar to the effect of a woodworking plane, or with the opposite oblique position a pressing of the fluid, in the case of the opposite oblique position. In addition, when the doctor blade is positioned obliquely, any bending of the latter has a direct effect on the gap between the working edge and the transport surface. A position perpendicular to the transport surface is therefore preferred.

Positioning the working edge of the doctor blade transversely to the direction of motion of the transport surface causes the surplus fluid to accumulate uniformly in front of the doctor blade, viewed from the direction of motion, due to the motion of the transfer wheel. Positioning it obliquely to the direction of motion would cause fluid to be forced in one direction in connection with the rotary motion of the transfer wheel, which could result in uneven distribution of the fluid along the working edge of the doctor blade. This is essentially prevented by positioning it transversely to the direction of motion.

Preferred is an application device according to the invention which is characterized in that the dispensing device has at least one spray nozzle, application nozzle and/or dispensing nozzle for spraying, applying or otherwise dispensing the fluid onto the transfer wheel. The dispensing device can vary according to the application, in particular the consistency of the fluid and the speed of motion of the transport surface. With fluids of lower viscosity, such as paints or varnishes, it is advantageous to spray the fluid onto the transport surface. Here the dispensing device is positioned at an interval from the transport surface. When using fluids of higher viscosity, for example cold glue, it is usual to apply a bead by means of an application nozzle that is positioned at a slight distance from the application surface, i.e. the transport surface. The application device is not limited to the two forenamed examples, however; instead the possibilities include additional dispensing nozzles, as well as the use of a nozzle arrangement consisting of a plurality of nozzles.

Advantageously, the axis of the transfer wheel during operation may be vertical, for example, and the area of smaller diameter of the transport surface points upward. The flowing of the fluid, in particular surplus fluid, due to the centrifugal force during rotation of the transfer wheel, is directed toward the largest diameter of the transport surface. With the transfer wheel in the forenamed vertical position this direction of flowing motion on the transport surface is simultaneously downward, so that it is supported by the force of gravity. Furthermore, the vertical position of the transfer wheel axis simplifies the design and positioning of the catch container. That is due in particular to the fact that no thrown-off fluid can be expected above the zone of the transport surface with the greatest diameter. In other words, a transfer wheel with a vertical axis does not throw any fluid upward.

In an advantageous design, the application device can also include a drive motor for moving the transfer wheel and a holding device for holding the transfer wheel, the motor, the dispensing device and/or possibly one or more doctor blades. A motor is provided for turning the transport wheel; the rotary motion during operation must be matched to the motion of the substrate.

The transfer wheel and the motor here are held in a holding device, with the transfer wheel normally sitting directly on the drive shaft of a geared motor, and whereby the holding of the motor makes additional holding of the transfer wheel superfluous. At the same time, the dispensing device, and the doctor blade—if present—are held in the same holder. This makes it possible to guarantee a fixed position of the dispensing device and the doctor blade in relation to the transfer wheel. The transfer wheel, the dispensing device, and the doctor blade—if any—form one solid mechanical unit together with the holding device. The holding device is designed in this case for example as a holding arm.

Such a holding arm is preferably attached so that it can rotate, there being a mechanism supplied to press the transfer wheel resiliently against the substrate. The spring enables a desired clamping pressure of the transfer wheel against the substrate to be set. In operation, slight motions of the transfer wheel can occur, for example when the contour is uneven. Such motions are carried out as motions of the swivel arm, so that the dispensing device and the doctor blade may move together with the transfer wheel, and their distance from the transfer wheel remains constant.

The catch container can be attached to a different holder, so that motions of the device that holds the transfer wheel result in relative motions between transfer wheel and catch container. However, the magnitude of such motions is normally in the range of a few millimeters, so that they do not impair the functional ability of the catch container. Flexible hoses or the like are used for the most part to feed captured fluid back from the catch container to the dispensing device, as well as to supply unused fluid; they are tolerant of the slight swiveling motions of the holding device during operation.

A use of the application device according to the invention can be described as:

A method for applying fluid to a contour of a substrate may comprise:
applying fluid from a fluid dispensing device onto the transport surface of the transfer wheel,
continuous turning of the transfer wheel, so that the transport surface rotates from the dispensing device to the contour,
smoothing of the fluid applied to the transport surface by means of a doctor blade, before the applied fluid reaches the contour,
guiding the substrate with the contour along the transport surface, during which a zone of the transport surface with a smaller diameter comes into contact with the contour, in particular it is pressed against it, and at the same time at least part of the fluid from the transport surface is applied to the contour,
wiping off at least part of the fluid that remained on the transfer wheel after the process of application to the contour of the substrate, before new fluid is applied to the transfer wheel at the dispensing advice, and
catching fluid that was thrown off of the transfer wheel, dripped off, was wiped off and/or missed the transfer wheel when delivered by the dispensing device.

The procedural steps of smoothing and/or wiping off fluid may be dispensable, depending on the application.

### BRIEF DESCRIPTION OF THE DRAWINGS

An exemplary embodiment of the present invention will be explained below on the basis of drawing figures.

FIG. 1 illustrates an application device according to the invention in a partial sectional view, in which the transfer wheel is represented in axial cross section.

FIG. 2 is a cross sectional view of a substrate that is to be coated.

### DETAILED DESCRIPTION OF THE DRAWINGS

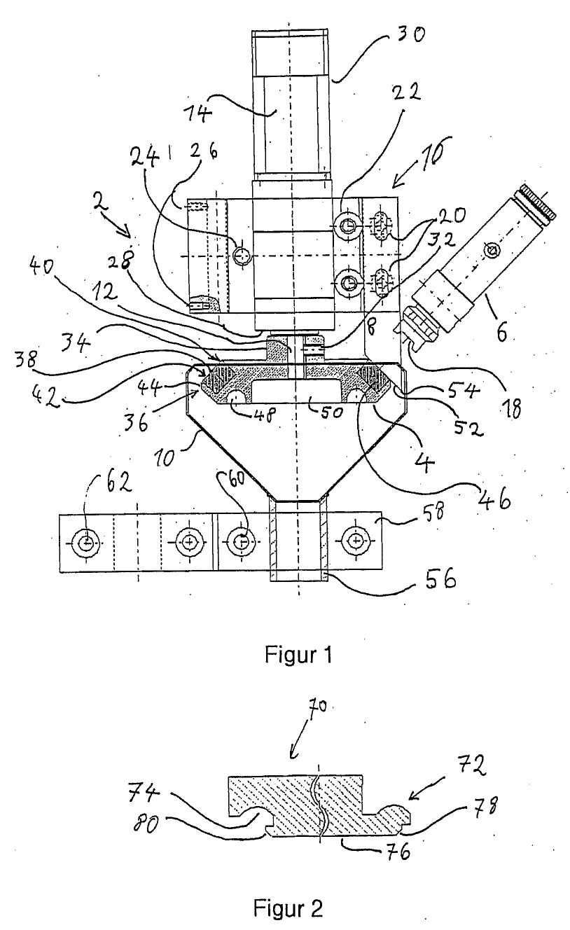

An application device 2 according to FIG. 1 has a transfer wheel 4, a fluid dispensing device 6 and a doctor blade 8 for wiping off surplus fluid. The transport wheel 4 and the doctor blade 8 are partially surrounded by a catch container 10, which is shown here schematically.

Transfer wheel 4 sits on the motor shaft 12 of the motor 14, which together with the doctor blade 8 is held by the holding device 16. Fluid dispensing device 6 here is also attached to holding device 16, although this connection to holding device 16 is not shown in FIG. 1. At the same time, fluid dispensing device 6 is designed with a nozzle 18 for spraying fluid onto transfer wheel 4.

Doctor blade 8 is firmly screwed to the holding device with attaching screws 20, and extends from there vertically to transfer wheel 4. Motor 14 is clamped in holding device 16 by means of set screws 22 and 24. Holding device 16 has additional threaded bores 26 for attaching the holding device to a swiveling mechanism, which is not shown.

When in its state of being clamped into holding device 16, the face 28 of motor 14 points downward out of the holding device. The rear part 30 of motor 14 protrudes upward out of holding device 16, so that the areas needed to cool it lie outside of the holding device. Motor shaft 12 protrudes vertically downward from the motor beyond the face 28. Transfer wheel 4 is attached to motor shaft 12 by means of a threaded bore 32 and a screw (not shown). Adjacent to attaching section 34 of transfer wheel 4, in which threaded bore 32 is also located, is the main section 36, which has on average a significantly larger diameter than attaching section 34. Located on main section 36 is transport surface 38, which is divided into a contact surface 40 located higher up and a flow surface 42 located lower down. The fluid is applied from fluid dispensing device 6 through nozzle 18 onto transport surface 38, essentially over its entire width. Only the contact surface 40 comes into contact with the contour to transfer the fluid from transport surface 38 to the contour of the substrate, however, so that fluid is only transferred there. Due to the rotary motion of transfer wheel 4 a centrifugal force acts on the remaining fluid; reinforced by gravitational force, it causes the fluid to flow on flow surface 42 in the direction of the greatest diameter 44 of transfer wheel 4. At the greatest diameter 44 of transfer wheel 4 fluid is then thrown off, since it cannot flow further outward.

FIG. 1 shows an exemplary embodiment of the application device according to the invention, in which transport surface 38 is realized by a silicon insert 46 in transfer wheel 4, which otherwise is made of metal. It has turned out however that it is not necessary to use a special material for transport surface 38, but rather that it is sufficient to form the shape of the transport surface according to the invention directly on the transfer wheel without changing the material. To achieve weight savings on transfer wheel 4, recesses 48 and 50 are provided.

Doctor blade 8 has a wiping or working edge 52, which is oriented perpendicular to transport surface 38 and at the same time transverse to the direction of motion of transport surface 38. The direction of motion of transport surface 38 in the area of working edge 52 of doctor blade 8 is directed into the plane of the drawing. Working edge 52 is positioned with practically no intermediate space with respect to transport surface 38. Viewed from the direction of motion of the transport surface, doctor blade 8 is in front of fluid dispensing device 6. Surplus fluid that is still on the transport surface 38 is wiped off of transport surface 38 at the doctor blade 8 by the latter's working edge 52, and can drip off of the doctor blade 8 in the area of the point 54.

Catch container 10, which is designed here as a funnel, surrounds both transfer wheel 4 and doctor blade 8 part way. Fluid that drips off of the doctor blade tip 54 thus collects in catch container 10. Catch container 10 surrounds transfer wheel 4 only in the area of flow surface 42 and of the greatest diameter 44 of transfer wheel 4, but not in the area of contact surface 40. Thus to apply fluid from contact surface 40 to the contour of a substrate the substrate can be guided outside of catch container 10, while on the other hand fluid thrown off in particular at the greatest diameter 44 is collected by the catch container. The funnel-shaped catch container 10 extends downward according to FIG. 1 into a pipe connection 56, through which collected fluid can be drained away and possibly returned to fluid dispensing device 6. At the same time, pipe connection 56 serves to hold catch container 10 in a separate holder 58. The screws 60 serve to clamp catch container 10 with its pipe connection 56 firmly in holder 58. Holder 58 in turn can be attached to other objects, such as a bar for example, by additional screws 62.

Substrate 70 of FIG. 2 is a floor covering panel in cross section, having a connecting profile 72 and 74 for joining a plurality of such panels together. The walking surface 76 of panel 70 faces downward in FIG. 2. Contour 78, which forms a joint with a second contour 78 of a second panel when a multitude of such panels are laid, is to be coated with fluid, in the present case with paint, by means of the application device according to the invention shown in FIG. 1. To this end, contour 78 of panel 70 is brought into contact with contact surface 40 of transport surface 38 of transfer wheel 4, and in the contact area is guided synchronously with contact surface 40. Here stepping surface 76 slides along above catch container 10.

Hence the following sequence results for a process for coating contour 78 of panel 70 with paint or some other fluid. Fluid dispensing device 6 places paint on transport surface 38 for example by spraying, the transfer wheel rotates its transport surface 38 further in the direction of the point of contact with panel 70, where contact surface 40 comes into contact with contour 78 and applies the paint to contour 78. Through rotation of transfer wheel 4, because of the centrifugal force part of the remaining paint flows along flow surface 42 in the direction of the greatest diameter 44 of transfer wheel 4, while a part of the paint is thrown off in the area of the greatest diameter 44 and captured by catch container 10. The remaining surplus part of the paint then reaches doctor blade 8 and is wiped off by means of its working edge 52, and drips or leaks at the doctor blade tip 54 into catch container 10, from where the paint is recycled.

While the present invention has been illustrated by the description of one or more embodiments thereof, and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. An application device for applying fluid to a contour of a substrate, having a transfer wheel for transferring the fluid from a fluid dispensing device, in particular a dispensing nozzle, onto the contour of the substrate, characterized in that the transfer wheel has a transport surface which tapers axially for transporting the fluid onto the contour.

2. An application device according to claim 1, characterized by at least one doctor blade for smoothing fluid and/or for wiping it from the transfer wheel.

3. An application device according to claim 1, characterized in that the transport surface has the form of the circumferential surface of a truncated cone.

4. An application device according to claim 3, characterized in that in the axial section through the transfer wheel the angle between the axis of the wheel and the sectional edge of the transport surface is between 20° and 70°, preferentially between 30° and 60°, most preferably 45°.

5. An application device according to claim 1, characterized in that a catch container is provided to collect surplus fluid.

6. An application device according to claim 5, characterized in that the catch container is essentially funnel-shaped.

7. An application device according to claim 1, characterized in that the transfer wheel, in particular its transport surface, is partially surrounded by the catch container.

8. An application device according to claim 1, characterized in that the transport surface protrudes partially from the catch container, in particular with a zone of smaller diameter.

9. An application device according to claim 1, characterized in that the wiping or working edge of the doctor blade is positioned essentially transversely to the direction of motion of the transport surface of the transfer wheel during operation, and the doctor blade at the same time is positioned essentially orthogonally in relation to the transport surface.

10. An application device according to claim 9, characterized in that the wiping or working edge of the doctor blade is positioned at the transport surface or at a slight distance from the transport surface.

11. An application device according to claim 1, characterized in that the dispensing device has at least one spray nozzle, application nozzle and/or dispensing nozzle for spraying, applying or otherwise dispensing the fluid onto the transfer wheel.

12. An application device according to claim 1, characterized in that the axis of the transfer wheel during operation is approximately vertical and the zone of tapering smaller diameter points upward.

13. An application device according to claim 1, also including:
a drive motor to move, in particular to turn the transfer wheel, and
a holding device to hold the transfer wheel the motor, the dispensing device and/or the one or more doctor blades, if any.

14. An application device according to claim 1, characterized by a mechanism for pressing the transfer wheel resiliently against the substrate.

15. A transfer wheel for use in an application device according to claim 1, for transferring the fluid from a dispensing device, in particular a dispensing nozzle, onto the contour, characterized in that the transfer wheel has an axially tapering transport surface for transporting the fluid from the dispensing device to the contour.

16. A transfer wheel according to claim 15, characterized in that the transport surface has the form of the circumferential surface of a truncated cone.

17. A transfer wheel according to claim 15, characterized in that in the axial section through the transfer wheel the angle between the axis of the wheel and the sectional edge of the transport surface is between 20° and 70°, preferentially between 30° and 60°, most preferably 45°.
